(19) United States
(12) Patent Application Publication
(10) Pub. No.: US 2006/0209763 A1
(43) Pub. Date: Sep. 21, 2006

(54) Multi-mode link adaptation

(76) Inventors: Stephen P. Emeott, Rolling Meadows, IL (US); Anthony J. Braskich, Palatine, IL (US); Nattavut Smavatkul, Bangbumru (TH)

Correspondence Address: MOTOROLA, INC., 1303 EAST ALGONQUIN ROAD, IL01/3RD, SCHAUMBURG, IL, 60196, US

(21) Appl. No.: 11/085,502

(22) Filed: Mar. 21, 2005

(51) Int. Cl. H04Q 7/00

(52) U.S. Cl. 370/332

(57) ABSTRACT

Multi-mode link adaptation in a wireless communication network where a station calculates a current link quality, a minimum link quality, and an excess link quality based upon the current link quality and the minimum link quality to determine an operating mode that is related to the success or failure of recent transmissions from the station. If the calculated excess link margin is lower than a first threshold, the station operates in a first mode, otherwise in another mode. In any case, the station selects the link rate for a new transmission from the station based upon the selected mode.

### FIELD OF THE INVENTION

The present invention relates generally to wireless communication systems and in particular to the field of link adaptation in a wireless network.

### BACKGROUND

A mobile device implemented according to an IEEE 802.11 wireless LAN standard has a benefit of being able to adjust its transmission rate based on the underlying path, also called a “link,” between its transmitter and a receiver. If the link quality is good, the mobile device may use a high transmission rate. On the other hand, if the link quality is poor, the mobile device must use a low transmission rate. This process of changing transmission rates based upon the link quality is commonly called link adaptation. Being able to change transmission rates when link conditions permit has benefits, such as more data can be transmitted and the transmission can be completed in a shorter amount of time. The first benefit, increased throughput, increases system capacity, decreases network congestion, and may reduce requirements relating to frequency spectrum. The second benefit, shorter transmission time, reduces transmission delay, saves battery life by allowing a handset to go to sleep faster, and may be less susceptible to interfering transmissions. In any event, link adaptation requires being able to identify an optimal transmit rate that allows the transmitter and the receiver to react quickly to changes in the link quality.

There are many existing metrics to characterize link quality, however, the existing techniques are lacking for a number of reasons. A first metric measuring the signal to noise plus interference ratio (SNIR) of the link may be difficult to estimate in practice because the noise component of a contention based link is difficult to quantify. A second metric, counting the number of acknowledgements received in response to transmissions is not a reliable indicator of when the link rate should be changed because it does not distinguish between erasures caused by changing link conditions and erasures due to collisions on the link. A third metric, using the received signal strength (RSS) of a received signal may not inform whether the link rate should be changed because RSS is very difficult to quantify and can rapidly change in the presence of multipath fading and interfering transmissions. Thus, prior art metrics available to characterize link quality and change link rates in response to the link quality are lacking.

Accordingly, there exists a need for an improved method of link adaptation.

### BRIEF DESCRIPTION OF THE FIGURES

The present invention is illustrated by way of example and not limitation in the accompanying figures, in which like references indicate similar elements, and in which:

FIG. 1 is an example of a simple block diagram illustrating a WLAN in accordance with some embodiments of the invention.

FIG. 2 is a flow diagram illustrating link adaptation in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail link adaptation in accordance with the present invention, it should be observed that the present invention resides primarily in combinations of method steps and apparatus components related to link adaptation. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

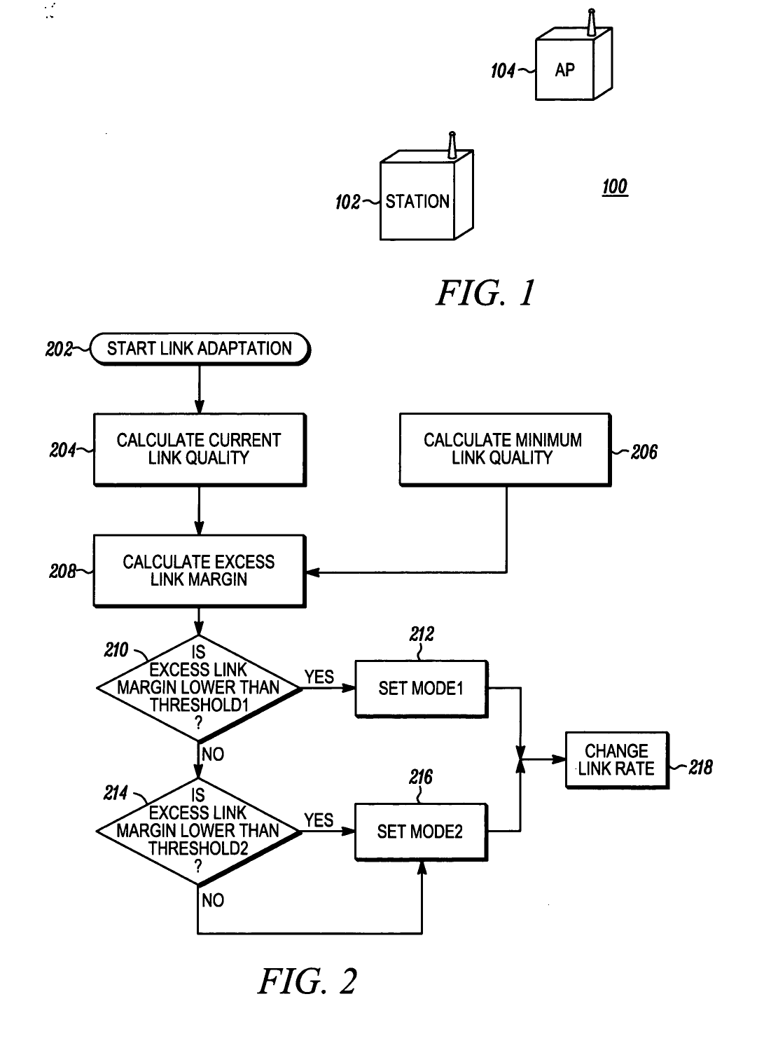

A method and apparatus for link adaptation based upon a calculated link quality and information about the success or failure of recent transmissions is disclosed. Referring to FIG. 1, a wireless communication system, such as a wireless local area network (WLAN) 100, according to the present invention illustratively includes an access point (AP) 104 and at least one station 102. The AP 104 may provide the station 102 with access to an underlying network that may be implemented, for instance, as a wired network or as a mesh network having fixed or mobile access points. The AP 104 may, for instance, be a base station. FIG. 1 shows one AP providing coverage to one client for the purpose of ease of illustration. However, it should be understood by those of ordinary skill in the art that a WLAN 100 may be designed with any number of access points and any number of clients. Station 102 may be any suitable type of wireless communications device capable of communicating within the WLAN 100, for instance, a laptop computer, a personal digital assistant, a voice handset, or any other suitable device as will be appreciated by those of skill in the art. The station may also be connected to a fixed communications infrastructure, if desired.

In one embodiment, the WLAN 100 may be an 802.11 WLAN network, wherein the station 102 and the AP 104 are configured to operate in accordance with the ANSI/IEEE (American National Standards Institute/Institute of Electrical and Electronics Engineers) 802.11 wireless LAN standards. Thus, the AP 104 may be, for instance, an 802.11 access point or base station. Alternatively, the WLAN 100 may adhere to another ANSI/IEEE 802 wireless standard, such as 802.15.1, 802.15.3, 802.15.4, 802.16, 802.20, 802.22, and the like. Further, the WLAN 100 may adhere to Global System for Mobile Communications (GSM) or other cellular standard. Thus, the mention of ANSI/IEEE 802.11 is not to be construed as a limitation.

Referring to FIG. 2, the process of link adaptation according to an embodiment of the present invention is shown. When the station 102 decides to communicate with the AP 104 it sends a transmission to the AP 104. In one embodiment, the process of link adaptation as shown in FIG. 2 is initiated when the station 102 begins a transmission. In any case, link adaptation is initiated (Block 202) and the station 102 calculates a current link quality (Block 204). In an embodiment of the present invention, calculating a current link quality (Block 204) is performed by retrieving previously measured signal strength values for previously received frames. Such values may be stored in a memory of the station 102. In one embodiment, such a calculation is performed by retrieving the previously measured Received Signal Strength (RSS) of the last valid measurement frame that the station 102 received, where a valid measurement frame is defined as a transmission that is a) transmitted at a power level the station 102 can ascertain, either based on the contents of the measurement frame or a priori information, and b) the reception of the measurement frame has at least a valid frame check sequence (FCS). An example of a potentially valid measurement frame is a special type of frame termed a beacon frame. As is known in the art, a beacon frame is a message used for signaling communications between the station 102 and the AP 104 and is often, sometimes periodically, sent between the two devices 102, 104. A beacon frame is a potentially valid measurement frame in wireless communication systems where transmit power levels may vary over time because a beacon frame may include a field specifying the transmit power selected each time the frame is transmitted. If transmit power is negotiated in advance or stays fixed for a known period of time, or if frame headers include a transmit power level, frames transporting user traffic may also be measurement frames.

In any case, utilizing the previously measured RSS from the last valid measurement frame is simple to implement but may be suboptimal if the link changes rapidly. For example, if the current link conditions have changed since the last valid measurement frame was received, perhaps due to a temporary increase or decrease in the noise or interference level, then the RSS measurement may provide an inaccurate estimate of the current link conditions. In an alternate embodiment, calculating a current link quality (Block 204) is performed by taking an average of RSS measurements from a number of valid transmissions. For example, the station 102 may take an average of RSS measurements from the last n valid transmissions where n may be variable based upon the amount of memory that the station 102 contains. In general, if the memory of the station 102 is large, then the number n may be large. Utilizing an average of RSS measurements may be effective to filter out RSS measurements that are inaccurate due to collisions on the link. In another embodiment, calculating a current link quality (Block 204) is performed by collecting one RSS sample during an x-microsecond window where x may be based on a length of time that the station 102 has available for calculating current link conditions. Utilizing one RSS sample obtained during a window and averaging over several windows may be effective to enforce time diversity of samples and for calculating a current link quality estimate that is uniform.

Continuing with FIG. 2, the station 102 calculates a minimum link quality to support the current link rate (Block 206). The station 102 takes the link rate it had selected for its last transmission to calculate the minimum link quality to support that link rate. In one embodiment, where the station 102 adheres to IEEE 802.11a standards, there are 8 possible link rates with 8 corresponding minimum link qualities to support those link rates. Shown below is a table that shows the relationship between link rates and received signal strength values for an IEEE 802.11a station, where the received signal strength values is an indication of the minimum link quality.

| Link Rate (Mbps) | Minimum Link Quality (dBm) |
|---|---|
| 6 | −82 |
| 9 | −81 |
| 12 | −79 |
| 18 | −77 |
| 24 | −74 |
| 36 | −70 |
| 48 | −66 |
| 54 | −65 |

Referring to the above table, if the station 102 made its last transmission at a link rate of 36 Mbps, then the minimum link quality for the link rate of 36 Mbps is calculated to be −70 dBm (Block 206).

Those skilled in the art will recognize that other link quality metrics may be used by the station 102 to calculate the current link quality (Block 204), such as link margin, and that the other link quality metrics may be used to calculate the minimum link quality for the current link rate (Block 206). For example, link margin is a metric that is calculated by first calculating the current link quality (Block 204) by taking the measured RSS between the AP 104 and the station 102 and adding to it the difference between the maximum transmit power of the AP 104 and the actual transmit power. Then, the link margin between the station 102 and the AP 104 may then be estimated by taking the current link quality (as calculated) between the AP 104 and the station 102 and subtracting from it the difference between the maximum transmit power of the AP 104 and the maximum transmit power of the station 102, and then further subtracting from it the receiver noise floor of the AP 102. In such a fashion, the minimum link quality for the current link rate is calculated (Block 206). When alternate metrics are employed, the calculated link quality would correspond to a minimum link quality value associated with the alternate metric.

Continuing with FIG. 2, the station 102 calculates an excess link margin (Block 208) by taking the difference of the current link quality and the minimum link quality for the current link rate (Block 208). For example, if the current link quality is −68 dBm and the minimum link quality for the current link rate is −70 dBm, then the excess link margin is calculated to be 2 dBm. As mentioned above, in one embodiment, calculating an excess link margin (Block 208) is performed whenever the station 102 is preparing to make a transmission to the AP 104.

The excess link margin is compared against at least one threshold (Blocks 210, 214). The threshold may be pre-calculated based upon simulation results or may be pre-calculated based upon experimental tests. In any case, a threshold is chosen and a corresponding mode is selected. Even though FIG. 2 shows only two thresholds, namely threshold1 and threshold2, an embodiment of the present invention may include any number of thresholds and a corresponding number of modes. To one of ordinary skill in the art, such a change is considered to be an obvious extension. In any case, the value of threshold is chosen to aid in determining the transmission rate. For example, a high excess link margin may imply that missed acknowledgement messages are most likely not caused by a lack of coverage, but by another factor, such as collisions. As a result, the station 102 may be able to successfully increase the transmit link rate with a smaller number of successful transmissions at the current link rate (Block 206), in the event that link adaptation is driven by the number of consecutive successful transmissions for example. Thus, in such a situation, the station 102 may set its mode to mode2 (Block 216), which influences a link adaptation algorithm (as described below and as known as “a multi-mode rate selection algorithm”) to more aggressively increase the transmission rate than when mode1 is selected, due to the high excess link margin. Alternatively, the station 102 may set its mode to mode1 (Block 212) to recognize a lower excess link margin. As used herein, the mode comprises a set of rate selection parameters, such as the triplet of parameters that correspond to a link adaptation algorithm based upon auto rate fallback (ARF), namely Ni, Nd, and Np. These parameters are rate selection variables that affect the link rate. In any case, the station 102 changes the mode of operation of the link adaptation algorithm based upon the excess link margin calculation (Block 208).

In an alternative embodiment, the station 102 may automatically select a default mode, e.g. mode 1, if the current link quality is unavailable, outdated or otherwise invalid. In such an implementation, the station 102 may not calculate the excess link margin. In an alternative embodiment, the station 102 may automatically set the excess link margin to −∞ to recognize that the value of the current link quality is not able to be calculated, is outdated or is otherwise invalid.

Having chosen the triplet of parameters, the station 102 selects a link rate for the transmission to the AP 104 using the link adaptation algorithm which as described below is termed a multi-mode rate selection algorithm (Block 218). In an embodiment of the present invention, the station 102 selects a rate using the ARF algorithm, where the ARF algorithm is characterized by three general principles. First, if a pre-defined number of consecutive acknowledgement messages for prior transmissions is missed (as used herein and in the art, Nd), then the transmission rate is reduced by one step to the next lower link rate. Second, if a pre-defined number of consecutive acknowledgement messages is received for prior transmissions (as used herein and in the art, Ni), then the transmission rate is increased by one step to the next higher link rate. Whether increasing or reducing the transmission rate, the set of available steps refers to a numerically ordered list of available transmission rates {r₁, r₂, . . . , rₘ}, where rᵢ<rᵢ₊₁ for i=1 . . . m, with a current transmission rate of rⱼ, such that a one-step increase sets the transmission rate to rⱼ₊₁, and a one-step decrease sets the transmission rate to rⱼ₋₁. A one step increase when the current transmission rate is rₘ or a one step decrease when the transmission rate is r₁ leaves the transmission rate unchanged. Third, if the station 102 wishes to try out a higher link rate, it attempts to use the new, higher link rate for each of a pre-defined number (as used herein and in the art, Np) of the next transmissions. In one embodiment, if any of the Np transmissions are correctly acknowledged, the station 102 commits itself to the higher rate. Otherwise, the station 102 returns to the previous transmission rate. Trying out a higher rate is known as a probation state.

In operation, each time the station 102 sends a transmission to the AP 104, the station 102 determines a transmission rate by comparing a number of consecutive acknowledgement messages received, e.g. N_{ack}, a number of consecutive acknowledgement messages missed, e.g. N_{nack}, and whether the station is in a probation state with the triplet of parameters, namely Ni, Nd, and Np.

For example, if the station 102 received an acknowledgement message to the last transmission, then the station will compare N_{ack} with the step-up threshold Ni to determine whether to increase the transmission rate. If Ni immediately preceding transmissions have been acknowledged (N_{ack}≧Ni), then the station 102 will assume that the link is good enough to support a higher transmission rate and use the next higher transmission rate. Otherwise, since N_{ack}<Ni, the station 102 will not increase the transmission rate and continue to use the same transmission rate.

On the other hand, if the station 102 did not receive an acknowledgement message to the last transmission, then the station will look back to determine the number of consecutive unacknowledged transmissions N_{nack}. Consecutive unacknowledged transmission is used to filter out any temporary link degradation and colliding transmission. If Nd immediately preceding transmissions have not been acknowledged (N_{nack}≧Nd), then the station 102 will presume that the link cannot support the current transmission rate and use the next lower transmission rate. Otherwise, since N_{nack}<Nd, the station 102 will not decrease the transmission rate and continue to use the same transmission rate.

Further, after a transmission rate increase, the station 102 enters a probation state. When the station is in this state, the fallback threshold Nd is replaced by a probation threshold Np. In one embodiment, Np is smaller than Nd to allow the station 102 to decrease the transmission rate back to a previous value after a smaller number of unacknowledged transmissions. In a conservative embodiment, where Np=1, the station 102 will try out a higher rate once, and will revert back to the previous rate after a single failure. Once it is apparent that the link can support the new transmission rate, the station 102 operates at the new transmission rate and exits the probation state.

An exemplary embodiment of the present invention provides superior features such as the following. First, the number of stations that can be supported in the wireless local area network 100 is increased by using an embodiment of the present invention. By choosing a link rate that is a more accurate reflection of the current link conditions instead of choosing a link rate that understates the current link conditions, more data can be transmitted and data transmissions can be completed in a shorter amount of time. The first benefit, increased throughput, increases system capacity, decreases network congestion, and reduces the number of frequencies required to support a given number of stations. The second benefit, shorter transmission time, reduces transmission delay, saves battery life by allowing a station to go to sleep faster, and reduces the number of interfering transmissions.

It will be appreciated the link adaptation described herein may be comprised of one or more conventional processors and unique stored program instructions that control the one or more processors to implement, in conjunction with certain non-processor circuits, some, most, or all of the functions of the link adaptation described herein. The non-processor circuits may include, but are not limited to, a radio receiver, a radio transmitter, signal drivers, clock circuits, power source circuits, and user input devices. As such, these functions may be interpreted as steps of a method to perform link adaptation. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for link adaptation in a wireless communication network comprising the steps of:
at a station:
calculating a current link quality for a link between the station and an access point in the wireless communication network wherein the link is associated with a link rate, a minimum link quality, and the current link quality;
calculating the minimum link quality for the link rate;
calculating an excess link margin based upon the calculated current link quality and the calculated minimum link quality;
operating in a first mode, if the calculated excess link margin is lower than a first threshold wherein the first mode comprises rate selection parameters that relate to success or failure of recent transmissions from the station; and
selecting the link rate for a new transmission from the station based upon the first mode.

2. The method of claim 1 wherein calculating the current link quality further comprises retrieving a previously measured Received Signal Strength (RSS) of a last valid measurement frame that the station received.

3. The method of claim 2 wherein the last valid measurement frame is a beacon frame wherein the beacon frame comprises a field specifying a transmit power selected when the frame is transmitted from an access point.

4. The method of claim 1 wherein calculating the current link quality further comprises calculating a link margin wherein the link margin is calculated from a Received Signal Strength (RSS) of a last valid measurement frame that the station received.

5. The method of claim 1 wherein calculating the excess link margin further comprises automatically setting the excess link margin to −∞ where the current link quality is not able to be calculated, is outdated or is otherwise invalid.

6. The method of claim 1 further comprising the step of operating in a second mode, if the calculated excess link margin is lower than a second threshold.

7. The method of claim 1 wherein selecting the link rate further comprises using an auto rate fallback algorithm.

8. The method of claim 7 wherein selecting the link rate further comprises increasing the link rate if a) the station received an acknowledgement message to a last message and b) a number of received acknowledgement messages is greater than Ni.

9. The method of claim 8 wherein increasing refers to a numerically ordered list of available transmission rates {r₁, r₂, . . . , rₘ}, where rᵢ<rᵢ₊₁ for i=1 . . . m, with a current transmission rate of rⱼ, such that an increase sets the transmission rate to rⱼ₊₁.

10. The method of claim 7 wherein selecting the link rate further comprises decreasing the link rate if a) the station did not receive an acknowledgement message to a last message and b) the number of unacknowledged messages is greater than Nd.

11. The method of claim 7 wherein selecting the link rate further comprises entering a probation state where the station increases the link rate for a temporary number of transmissions to determine whether the higher link rate can be supported by the link before changing the link rate for subsequent transmissions.

12. A station in a wireless communication network comprising:
an interface to a wireless link between the station and an access point wherein the wireless link is associated with a link rate, a minimum link quality, and a current link quality;
a control system for calculating the current link quality, the minimum link quality, and an excess link margin based upon the calculated link quality and the calculated minimum link quality;
a control system for determining whether the excess link margin is lower than a first threshold and setting an operating mode based upon the excess link margin; and
a link adaptation system for selecting the link rate for a transmission from the station based upon the set operating mode;
wherein the link adaptation system changes the link rate based upon the mode and whether recent transmissions from the station have been successful.

13. The system of claim 12 wherein the current link quality is a previously measured Received Signal Strength (RSS) taken from a last valid measurement frame that the station received.

14. The system of claim 12 wherein the operating mode comprises a set of rate selection parameters.

15. The system of claim 14 wherein the link adaptation system implements an auto rate fallback algorithm.

16. The system of claim 15 wherein the link adaptation system increases the link rate if a) the station received an acknowledgement message to a last message and b) a number of received acknowledgement messages is greater than Ni.

17. The system of claim 16 further comprising a numerically ordered list of available transmission rates {r₁, r₂, . . . , rₘ}, where rᵢ<rᵢ₊₁ for i=1 . . . m.

18. The system of claim 15 wherein the link adaptation system decreases the link rate if a) the station did not receive an acknowledgement message to a last message and b) the number of unacknowledged messages is greater than Nd.

19. The system of claim 15 wherein the link adaptation system enters a probation state where the station increases the link rate for a temporary number of transmissions to determine whether the higher link rate can be supported by the link before changing the link rate for subsequent transmissions.

20. A system for link adaptation in a wireless communication network comprising the steps of:
means for calculating a current link quality for a link between a station and an access point in the wireless communication network wherein the link is associated with a link rate, a minimum link quality, and the current link quality;
means for calculating the minimum link quality for the link rate;
means for calculating an excess link margin based upon the calculated current link quality and the calculated minimum link quality;
means for operating in a first mode, if the calculated excess link margin is lower than a first threshold wherein the first mode comprises rate selection parameters that relate to success or failure of recent transmissions from the station; and
means for selecting the link rate for a new transmission from the station based upon the first mode.
